(19) United States
(12) Patent Application Publication
(10) Pub. No.: US 2008/0127564 A1
(43) Pub. Date: Jun. 5, 2008

(54) PRE-HUNG DOOR ASSEMBLY AND METHOD OF INSTALLATION

(75) Inventors: Cordell R. Burton, Pella, IA (US); Thomas C. Swank, Cincinnati, OH (US); William W. Kling, Florence, KY (US); John Kreimer, Erlanger, KY (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Pella Corporation, Pella, IA (US)

(21) Appl. No.: 12/016,656

(22) Filed: Jan. 18, 2008

Related U.S. Application Data
(63) Continuation-in-part of application No. 11/427,636, filed on Jun. 29, 2006.
(60) Provisional application No. 60/978,901, filed on Oct. 10, 2007.

(51) Int. Cl. E06B 3/263; E06B 7/00

(52) U.S. Cl. 49/380; 52/745.16

(57) ABSTRACT

Methods for installing a door assembly in a rough opening at a job site include performing the following steps at a location remote from the job site where the door is to be installed: positioning a door frame around a perimeter edge of a door panel; attaching the door panel to the door frame with a plurality of hinges to comprise a pre-hung door; retaining the door frame square with respect to the door panel; attaching a plurality of mounting brackets to the pre-hung door. The method also includes inserting the pre-hung door into the rough opening at the job site and attaching the mounting brackets to the rough opening to support the door panel for opening and closing before the door frame is attached to the rough opening.

The present application is a continuation-in-part of U.S. patent application Ser. No. 11/427,636 entitled WINDOW INSTALLATION METHOD, filed Jun. 29, 2006, and the present application claims the benefit of U.S. Provisional Application Ser. No. 60/978,901 entitled PRE-HUNG DOOR ASSEMBLY AND METHOD OF INSTALLATION, filed on Oct. 10, 2007, both of which are hereby incorporated by reference.

### TECHNICAL FIELD

The present invention relates to installation features and methods of installing pre-hung door assemblies, and in particular, to mounting brackets that attach the pre-hung door assembly to the rough opening to support the door panel for opening and closing before the door frame is attached to the rough opening.

### BACKGROUND OF THE INVENTION

In a large percentage of installed doors, either commercial or residential, builders or other installers purchase the doors as pre-hung door assemblies. A pre-hung door assembly is delivered for installation with the door already hinged, or hung, to the framed-up jamb assembly, also described as a door casing or door frame. This is accomplished by attaching the door to one side of the jamb assembly by a hinge or hinges, or other securing means. The other side of the door is usually provided with a lockset and knob opening. The jamb member positioned immediately adjacent to the lockset and knob opening side is fixed with a latch or striker plate opening so that the door can be securely shut after it has been installed.

The door is typically shipped to a retailer, builder, or consumer inside of the jamb assembly. That is, the door is shipped in a “closed” position within the jamb assembly. Spacers, mechanisms that mechanically retain the door frame square with respect to the door panel, can be additionally or alternatively inserted between the door and the jamb assembly to keep the door closed. Some spacers are formed of thin pieces of wood or paper material, such as cardboard. The spacers can be discrete structures or part of the packaging for the door and can be secured and held in place in between the edges of the door and jamb assembly using nails, adhesive, or other fastening means. The entire pre-hung door assembly can then be strapped with a cellophane material or the like.

Installation of the pre-hung door assembly is traditionally accomplished by preparing a rough opening in a wall by installing any flashing, additional studs, sill supports, beads of sealant or other making other preparations. The pre-hung door assembly is then inserted into the rough opening. Generally, the bottom of the pre-hung door assembly is placed on the bottom of the rough opening and tilted back into place. Where the pre-hung door assembly will serve as an exterior door, the door assembly is typically inserted from the exterior of the building into the rough opening. The pre-hung door assembly is then plumbed and shimmed into place by inserting shims at each hinge location between the door assembly and the sides of the rough opening. Additional shims are inserted as needed to help ensure a plumb fit.

After the door has been plumbed, a nail or screw is then driven into the lock jamb of the door assembly next to each shim to steady the door assembly. The door is then opened and any stabilizer means and packaging are removed. On each hinge a long screw or nail is driven into an open screw hole in the hinge, with the screw or nail passing through the hinge, the casing, the shims at the hinges, and into the structural framing forming the rough opening. The door is then checked for operation and, where adjustable, the threshold height is adjusted as desired for proper opening and closing of the door.

### BRIEF SUMMARY OF THE INVENTION

Certain embodiments of the present invention relate to a method and apparatus for attaching a door assembly to the rough opening with mounting brackets to support the door panel for opening and closing before the door frame is attached to the rough opening. Once the mounting brackets are attached to the rough opening, the door can be opened and closed to facilitate further installation. The door panel does not sag or shift during operation or during the remainder of the installation. As a result, door assemblies can be installed more quickly and easily by lower skilled workers.

The mounting brackets also increase the strength, and hence the security, of the door assembly. In some embodiments, the fasteners attaching the mounting bracket to the rough opening are arranged in shear, substantially increasing the strength of the door assembly.

In some embodiments, the mounting brackets can be folded to facilitate shipping and handling. The mounting brackets are preferably attached to the door assembly at a location remote to the installation site. As used herein, “remote location” refers a location remote from the rough opening, such as a manufacturing facility or a ware house.

The present method and apparatus can also be used to install a variety of other closure assemblies in a rough opening, such as for example double-hung, casement, awning and fixed windows, skylights, sliding and hinged double doors, and the like. As used herein, “rough opening” refers to an opening in a wall or structure that has a perimeter sized and shaped to receive the closure assembly, and a plurality of inner surfaces.

One embodiment of the invention relates to methods for installing a door assembly in a rough opening at a job site. The following steps are preferably performed at a location remote from the job site where the door is to be installed: positioning a door frame around a perimeter edge of a door panel; attaching the door panel to the door frame with a plurality of hinges to comprise a pre-hung door; retaining the door frame square with respect to the door panel using at least one spacer; attaching a plurality of mounting brackets to the pre-hung door. The method also includes inserting the pre-hung door into the rough opening at the job site and attaching the mounting brackets to the rough opening to support the door panel for opening and closing before the door frame is attached to the rough opening.

In a preferred embodiment, the pre-hung door is inserted from the interior side of the rough opening and the mounting brackets are attached to an interior surface of the rough opening.

Another aspect of the invention relates to methods of installing a pre-hung door assembly in a rough opening in a building. Some embodiments include providing a pre-hung door assembly comprising a jamb assembly, a door, a plurality of hinges securing the door to the jamb assembly, and a plurality of mounting brackets for securing the jamb assembly to at least one building frame member adjacent the rough opening. The pre-hung door assembly is preferably inserted into the rough opening from an interior of the building. The mounting brackets are secured to a first vertical frame member adjacent the rough opening using a plurality of fasteners. The door of the pre-hung door assembly is opened after securing the mounting brackets to the at least one frame member. The jamb assembly is secured to a second vertical frame member positioned on an opposite side of the rough opening as the first frame member using a plurality of fasteners.

Still another aspect of the invention relates to kits for installing a door in a rough opening. Some embodiments include a door frame extending around a perimeter edge of a door panel. A plurality of hinges attaches the door panel to the door frame comprising a pre-hung door assembly. Additionally, at least one spacer retains the door frame square with respect to the door panel. The kit also includes a plurality of mounting brackets are adapted to attach the pre-hung door to the rough opening, where the mounting brackets support the door panel for opening and closing before the door frame is attached to the rough opening.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE SEVERAL VIEWS OF THE DRAWING(S)

FIG. 1 shows a pre-hung door assembly installed in a rough opening in a wall, according to some embodiments of the present invention.

FIG. 2 shows a cross-section taken along line X-X of FIG. 1 showing a hinge and mounting bracket of the pre-hung door assembly, according to some embodiments of the present invention.

FIG. 3 shows a front view of the hinge and mounting bracket of FIG. 2, according to some embodiments of the present invention.

FIG. 4 shows a cross-section of another hinge and mounting bracket of the pre-hung door assembly of FIG. 1, according to some embodiments of the present invention.

FIG. 5 shows a front view of the hinge and mounting bracket of FIG. 4, according to some embodiments of the present invention.

FIG. 6 shows a cross-section of another hinge and mounting bracket of the pre-hung door assembly of FIG. 1, according to some embodiments of the present invention.

FIG. 7 shows a front view of the hinge of FIG. 6, according to some embodiments of the present invention.

FIG. 8 shows a front view of the mounting bracket of FIG. 6, according to some embodiments of the present invention.

While the invention is amenable to various modifications and alternative forms, specific embodiments have been shown by way of example in the drawings and are described in additional detail in the following section. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

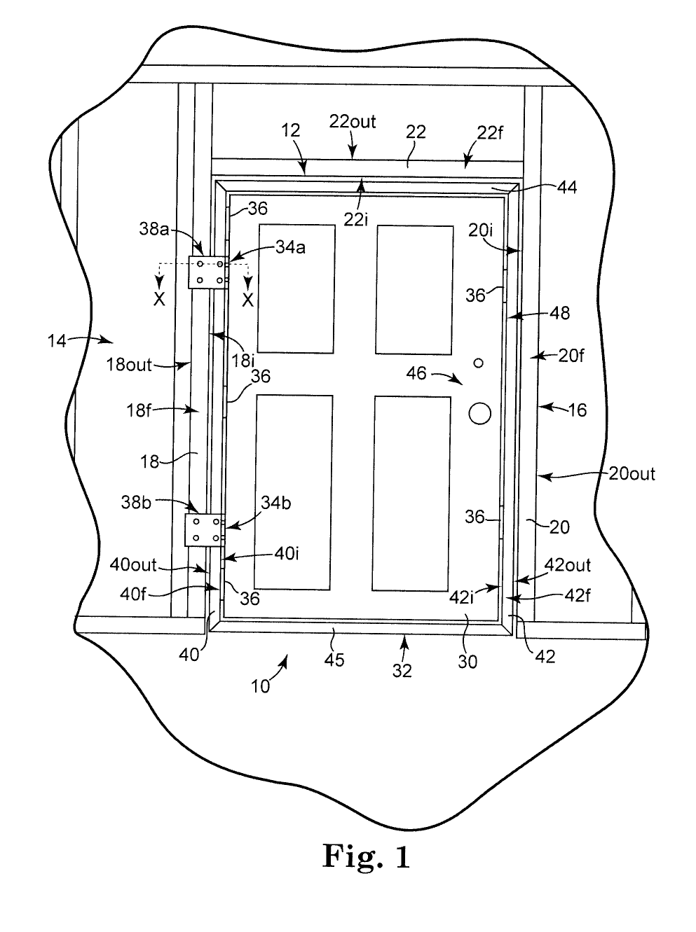

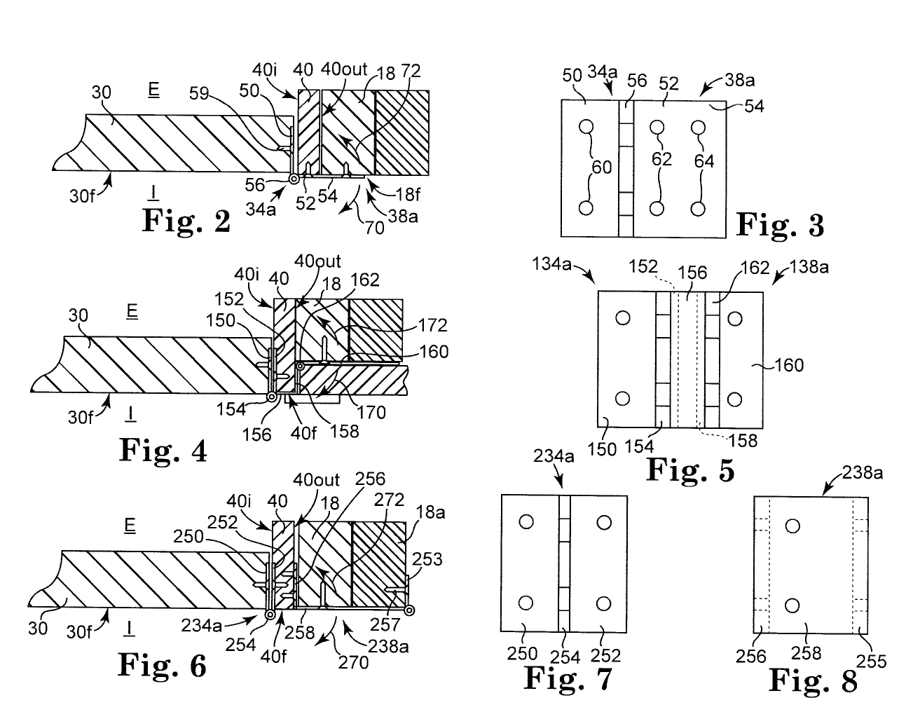

FIG. 1 shows a pre-hung door assembly 10 installed in a rough opening 12 formed in a wall structure 14, according to some embodiments of the invention. As shown, the wall structure 14 includes framing 16 defining the rough opening 12, where the framing 16 includes first and second vertical framing members 18, 20 and a horizontal framing member 22 formed of a suitable building material, such as wood studs. The framing members 18, 20, 22 have front faces 18f, 20f, 22f, inward faces 18i, 20i, 22i, and outward faces 18out, 20out, and 22out, respectively. In some embodiments, the pre-hung door assembly 10 is adapted for use as an exterior door, where the front faces 18f, 20f, 22f face toward a building interior I (FIG. 2) and opposite an exterior E (FIG. 2) of the building.

The pre-hung door assembly 10 includes a door 30, a jamb assembly 32, hinges 34a, 34b (collectively, “34”), spacers 36, and mounting brackets 38a, 38b (collectively, “38”). In some embodiments, the door 30 and jamb assembly 32 are delivered to the construction site pre-assembled so that the builder may easily install the door 30 and jamb assembly 32 into a door opening. The spacers 36, or other stabilizing means are provided with the pre-hung door assembly 10 to facilitate shipping and installation, as will be described in greater detail. Other mounting bracket configurations are disclosed in U.S. patent application Ser. No. 11/427,636, filed Jun. 29, 2006, entitled WINDOW INSTALLATION METHOD, the is hereby incorporated by reference.

The door 30, also described as a door panel 30, is configured as desired, for example as an exterior door suitable as an entryway into a building structure, where the door 30 defines a front face 30f toward the interior of the building. The jamb assembly 32, also described as a door casing or door frame, includes first and second, substantially parallel, spaced apart vertically extending jamb members 40, 42, a horizontally extending jamb member 44 that connects the first and second vertical jamb members 40, 42, and a sill 45. The jamb members 40, 42 define front, inward, and outward faces 40f, 40i, 40out, 42f, 42i, 42out, respectively. The hinges 34 securely attach the door 30 to the first jamb member 40. On the side opposite the hinges 34, the door 30 is prepared with a lockset/knob opening 46. A reveal space 48, or gap 48, between the door 30 and the jamb members 40, 42, 44 facilitates free opening and closing of the door 30 within the jamb assembly 32. The reveal space 48 is relatively small, for example 3/32 of an inch for an interior door and ⅛ of an inch for an exterior door, although smaller or larger reveal spaces are contemplated.

The present pre-hung door assembly 10 can optionally be used in combination with a drainage system under the sill 45, such as disclosed in U.S. patent application Ser. No. 11/340,253, entitled High Performance Window and Door Installation, filed Jan. 1, 2006, which is hereby incorporated by reference. Shim are typically located between the frame 16 and the jamb assembly 32, such as for example the shims disclosed in U.S. patent application Ser. No. 11/089,847, entitled Installation Method and System for A Closure Unit, filed Mar. 25, 2005, which is hereby incorporated by reference.

In some embodiments, the spacers 36 are inserted between the door 30 and the jamb assembly 32 in order to help maintain the reveal space 48 and to help keep the door 30 closed during shipping and installation, for example. The spacers 36 are mechanisms that mechanically retain the door frame square with respect to the door 30. In some embodiments, the spacers 36 are formed of thin pieces of wood, plastic, or paper material, such as cardboard, although any of a variety of materials and configurations are contemplated. The spacers 36 are optionally discrete structures or part of the packaging for the door assembly 10.

In some embodiments, the spacers 36 are secured and held in place in between the door 30 and the jamb members 40, 42, 44 using friction, nails, adhesive, or other appropriate fastening means (not shown). Although various configurations of the spacers 36 are described above, it should be understood that the spacers 36 can take on a variety of configurations as desired to serve as stabilizing means. In addition or as an alternative to the spacers 36, in order to facilitate shipping/storage of the pre-hung door assembly 10 the entire door 30 and jamb assembly 32 may be wrapped in cellophane material or other shipping packaging.

The hinges 34 include substantially similar features in some embodiments, which can be described cumulatively with reference to the hinge 34a. In turn, the mounting brackets 38 can be described cumulatively with reference to the mounting bracket 38a. The hinge 34a and bracket 38a are formed of the same or different materials as desired, including various suitable metals and plastics. The hinge 34a and mounting bracket 38a are formed as connected pieces, although in some embodiments the hinge 34a and mounting bracket 38a are formed as separate, unconnected pieces as will be described in greater detail.

FIG. 2 is a cross-sectional view along line X-X of FIG. 1 showing the hinge 34a and the mounting bracket 38a in greater detail. FIG. 3 is a front view of the hinge 34a and mounting bracket 38a, with the hinge 34a opened ninety-degrees from the position shown in FIG. 2. With reference to FIGS. 2 and 3, the hinge 34a and mounting bracket 38a together include a first portion 50, a second portion 52, a third portion 54, and a pivot 56. The first portion 50 has holes 60 and is adapted to be secured to the door 30, the second portion 52 has holes 62 and is adapted to be secured to the jamb member 40, and the third portion 54 has holes 64 and is adapted to be secured to the vertical member 18. Screws 59 or other appropriate fasteners can be inserted through the holes 60, 62, 64 to secure them to the desired structures.

The pivot 56 rotatably connects the first and second portions 50, 52, such that the first and second portions 50, 52 and the pivot 56 form the hinge 34a where the relative rotation between the first and second portions 50, 52 is sufficient to open and close the door 30. The remaining portions generally define the mounting bracket 38a, which extends from the hinge 34a. As will be described in greater detail below, the third portion 54 serves as the mounting bracket 38a and is adapted to support the door assembly 10 in an aligned position as part of installation of the pre-hung door assembly 10. In other words, the mounting bracket 38a is an extension of the hinge 34a.

In some embodiments, the second and third portions 52, 54 are connected, one extending fluidly from the other, and are also adapted to be manually pivoted or rotated toward and away from one another. For example, the second portion 52 and/or third portion 54 are optionally formed of a material and are otherwise sized and shaped to be manually bent. In some embodiments, the third portion 54 is a foldable, sheet metal tab. In other embodiments, a second pivot (not shown) similar to the pivot 56 attaches the second and third portions 52, 54 in a rotatable fashion. Regardless, in some embodiments, the third portion 54 is foldable toward the front face 30f of the door 30 and/or toward the outward face 40out of the jamb member 40 as designated by arrows 70, 72, respectively.

This folding, or collapsing feature is used in some embodiments to facilitate shipping and packaging of the door 30, where the third portion 54 is folded inwardly against a surface of the door 30 or jamb member 40 prior to installation, for example to reduce the outer profile of the pre-hung door assembly 10 and/or the likelihood the third portion would scratch, snag, or damage other items. However, it should be understood that in other embodiments the second and third portions 52, 54 are substantially rigidly secured to one another and are not adapted to be manually pivoted or bent.

FIG. 4 is a cross-sectional view showing another hinge 134a and mounting bracket 138a usable with the pre-hung door assembly 10 (FIG. 1) according to some embodiments. FIG. 5 is a front view of the hinge 134a and mounting bracket 138a, with the hinge 134a opened ninety-degrees from the position shown in FIG. 4. With reference to FIGS. 4 and 5, the hinge 134a and mounting bracket 138a together include a first portion 150, a second portion 152, a first pivot 154 between the first and second portions 150, 152, a third portion 156, a fourth portion 158, a fifth portion 160, and a second pivot 162 between the fourth and fifth portions 158, 160.

The first portion 150 is adapted to be secured to the edge of the door 30, the second portion 152 is adapted to be secured to the inside of the jamb member 40, the third portion 156 is adapted to extend over the front face 40f of the jamb member 40, the fourth portion 158 is adapted to extend over the outward face 40out of the jamb member 40, and the fifth portion 160 is adapted to be secured to the vertical framing member 18. In other words, the first and second portions 150, 152 and the first pivot 154 form the hinge 134a, where the first and second portions 150, 152 serve as a door side plate and a door frame side plate, respectively. Similarly to other embodiments, screws or other appropriate fasteners can be inserted through holes in the portions to secure them to the desired structures.

The first pivot 154 allows relative rotation of the first and second portions 150, 152 so that the door 30 can be rotated to open and closed positions. The second and third portions 152, 156 are angularly offset by about ninety degrees as shown in FIG. 4. The third portion 156 extends from and is secured to any of the first portion 150, the second portion 154, and/or the first pivot 156 as desired. The fourth portion 158 extends from and is angularly offset by about ninety degrees from the third portion 156.

The fifth portion 160 is rotatably connected to the fourth portion 158 with the second pivot 162. The fifth portion 160 can be rotated to a substantially orthogonal position relative to the fourth portion 158 using the second pivot 162 and folded forward onto the fourth portion 158 and/or backward toward the outward face 40out of the jamb member 40 for shipping/storage similarly to other embodiments and as designated by arrows 170, 172, respectively. As will be described in greater detail below, the fifth portion 160 is adapted to support the door assembly 10 in an aligned position as part of installation of the pre-hung door assembly 10.

Although as shown in FIGS. 4 and 5, the second pivot 162 is implemented to provide rotation between the fourth and fifth portions 158, 160, the portions 158, 160 are optionally directly secured to one another with one or both of the portions 158, 160 adapted to allow manual, relative rotation toward and away from one another.

Regardless, in some embodiments, the fifth portion 160 is foldable toward the fourth portion 158 and/or toward the outward face 40out of the jamb member 40 as designated by arrows 170, 172, respectively. This feature is used in some embodiments to facilitate shipping and packaging of the pre-hung door assembly 10, where the fifth portion 160 is folded inwardly prior to installation, for example to reduce the outer profile of the pre-hung door assembly 10 and/or the likelihood the fifth portion 160 would scratch, snag, or damage other items. However, it should be understood that in other embodiments the fourth and fifth portions 158, 160 are substantially rigidly secured to one another and are not adapted to be manually pivoted or bent.

FIG. 6 is a cross-sectional view showing another hinge 234a and separate, unconnected mounting bracket 238a usable with the pre-hung door assembly 10 (FIG. 1) according to some embodiments. FIG. 7 is a front view of the hinge 234a with the hinge 234a opened ninety-degrees from the position shown in FIG. 6. FIG. 8 is a front view of the mounting bracket 238a. The hinge 234a includes a first portion 250, a second portion 252, and a pivot 254 connecting the first and second portions 250, 252. The first portion 250 is adapted to be secured to the outer edge of door 30 and the second portion 252 is adapted to be secured to the inside of the jamb member 40. Screws or other appropriate fasteners can be used to secure the portions 250, 252 to the desired structures. The first pivot 254 allows relative rotation of the first and second portions 250, 252 so that the door 30 can be rotated to open and closed positions.

In an alternate embodiment, the second portion 252 is elongated with a third portion 253 attached by pivot 255. The third portion 253 preferably extends around the vertical framing member 18a so that fastener 257 is configured in shear relative to the front face 30f.

The mounting bracket 238a includes a third portion 256 and a fourth portion 258. The third and fourth portions 256, 258 are connected, one extending fluidly from the other, where the mounting bracket is substantially L-shaped in the open position shown in FIG. 6. As will be described in greater detail below, the mounting bracket 238a is adapted to support the door assembly 10 in an aligned position as part of installation of the pre-hung door assembly 10. In some embodiments, the third and fourth portions 256, 258 are also adapted to be manually rotated toward and away from one another. For example, the third portion 256 and/or fourth portion 258 are optionally formed of a material and are otherwise sized and shaped to be manually bent. In some embodiments, the mounting bracket 238a is formed as a foldable, sheet metal bracket. In other embodiments, a second pivot (not shown) similar to the first pivot 254 attaches the second and third members 256, 258 in a rotatable fashion.

Regardless, in some embodiments, the fourth portion 258 is foldable toward the front face 30f of the door 30 and/or toward the outward face 40out of the jamb member 40 and the second portion 256 as designated by arrows 270, 272, respectively. This feature is used in some embodiments to facilitate shipping and packaging of the door, where the fourth portion 258 is folded inwardly toward the front face 30f of the door 30 or the outward face 40out of the jamb member 40 prior to installation, for example to reduce the outer profile of the pre-hung door assembly 10 and/or the likelihood the fourth portion 258 would scratch, snag, or damage other items. However, it should be understood that in other embodiments the mounting bracket 238a is substantially rigid and not otherwise adapted to be manually bent or pivoted.

As best understood with reference to FIG. 1, in some embodiments, the pre-hung door assembly 10 is provided to the installer by performing a series of steps at a remote location away from the job site where the assembly 10 is ultimately to be installed. In some embodiments, the steps at the remote location include assembling and positioning the jamb assembly 32 around the edge of the door 30; attaching the door 30 to the jamb assembly 32 with the hinges 34 to pre-hang the door 30; and retaining the door 30 and jamb assembly 32 square with respect to one another using the spacers 36; and attaching the mounting brackets 38 to the jamb assembly 32 to form the pre-hung door assembly 10. In some embodiments, the mounting brackets 38 are pivotally attached to the jamb assembly 32. In other embodiments, the mounting brackets 38 are rigidly, or non-pivotably, attached to the jamb assembly 32.

In particular, the hinges 34 are secured on an exterior perimeter surface of the door 30 and to the inside of the jamb assembly 32. In turn, the mounting brackets 38 are either pivotally or rigidly attached to the hinges 34. The spacers 36 are attached to at least one of the perimeter edge of the door 30 and the jamb assembly 32. One or more holes are pre-drilled in the jamb assembly 32 as desired for securing the jamb assembly 32 in the rough opening 12. In some embodiments, the mounting brackets 38 are positioned in a folded position at the remote location, with the mounting brackets 38 being substantially coplanar with and folded against a surface of the pre-hung door assembly 10.

In some embodiments, prior to or during installation, the mounting brackets 38 are unfolded to an open position such that they extend outwardly from the jamb assembly 32 and parallel to a major surface of the door 30. The pre-hung door assembly 10 is inserted into the rough opening 12 from the interior side of the rough opening 12 at the job site and the mounting brackets 38 are attached to an interior surface of the rough opening 12, such as the front faces 18f, 20f, 22f of one or more of the framing members 18, 20, 22 to support the pre-hung door assembly 10 within the rough opening 12 prior to directly securing the jamb assembly 32, prior to opening the door 30, and/or prior to removing the spacers 36. The various embodiments described with reference to the mounting brackets 138, 238 can be substantially similarly employed.

In some embodiments, after the mounting brackets 38 are secured to the framing member 18, shims (not shown) are located between the jamb assembly 32 and the framing members 18, 20, 22 to further orient the pre-hung door assembly 10 within the rough opening 12. Then, the spacers 36 are removed and the door 30 is opened relative to the jamb assembly 32. The jamb assembly 32 is then attached to framing members 18, 20, 22 using nails or screws, for example. In some embodiments, the hinges 34 include an open hole for receiving a long screw or nail (not shown) to secure the jamb member 40 to the frame member 18. The jamb member 42 is nailed or screwed to the framing member 20 as needed.

In view of the foregoing, various embodiments of the pre-hung door assembly 10 allow installation from an interior of a building structure, in direct contrast to the long standing practice of installing pre-hung doors from the exterior of the building structure. For example, the installer is able to receive a pre-hung door with previously installed mounting brackets and use those brackets to initially install the door in a rough opening. Further squaring, for example shimming, proceeds with ease and the door can be opened prior to fastening the jamb assembly to the frame surrounding the rough opening. Furthermore, the mounting brackets are foldable and adapted for ease of shipping according to various embodiments. Although some benefits associated with various embodiments are described, it should be understood that additional or alternative benefits and features are contemplated.

Additionally, various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

The following is claimed:

1. A method for installing a pre-hung door assembly in a rough opening at a job site, the method comprising the steps of:
performing at a location remote from the job site the steps of positioning a door frame around a perimeter edge of a door panel and attaching the door panel to the door frame with a plurality of hinges to comprise a pre-hung door;
retaining the door frame square with respect to the door panel;
attaching a plurality of mounting brackets to the pre-hung door;
inserting the pre-hung door assembly into the rough opening at the job site; and
attaching the mounting brackets to the rough opening to support the door panel for opening and closing before the door frame is attached to the rough opening.

2. The method of claim 1 comprising the step of inserting the pre-hung door from an interior side of the rough opening.

3. The method of claim 1 comprising the steps of attaching the mounting brackets to an interior surface of the rough opening.

4. The method of claim 1 comprising the step of attaching the door frame to the rough opening.

5. The method of claim 1, wherein the mounting brackets are initially provided in a folded configuration for transportation, the method further comprising unfolding the mounting brackets to an open position prior to securing the mounting brackets to the rough opening.

6. The method of claim 1 comprising the steps of:
opening the door panel relative to the door frame;
locating shims between the door frame and the rough opening; and
attaching the door frame to the rough opening.

7. The method of claim 1 comprising pivotally attaching the mounting brackets to the door frame.

8. The method of claim 1 comprising rigidly attaching the mounting brackets to the door frame.

9. The method of claim 1 wherein the step of attaching a plurality of mounting brackets to the pre-hung door comprises attaching a plurality of hinges on an exterior perimeter surface of the door frame.

10. The method of claim 1 comprising pivotally attaching the mounting brackets to the hinges.

11. The method of claim 1 comprising rigidly attaching the mounting brackets to the hinges.

12. The method of claim 1 comprising pivotally attaching the mounting brackets to a door side plate and a door frame side plate of the hinge.

13. The method of claim 1 comprising the steps of:
positioning the mounting brackets coplanar with a surface of the pre-hung door at the location remote from the job site; and
positioning the mounting brackets parallel to a major surface of the door panel before attaching the mounting brackets to the interior surface of the rough opening.

14. The method of claim 1 comprising attaching at least one spacer to at least one of the door panel and the door frame.

15. The method of claim 1 comprising pre-drilling at the location remote from the job site one or more holes in the door frame to secure the door frame to the rough opening.

16. A method of installing a pre-hung door assembly in a rough opening in a building, the method comprising:
providing a pre-hung door assembly comprising a jamb assembly, a door, a plurality of hinges securing the door to the jamb assembly, and a plurality of mounting brackets for securing the jamb assembly to at least one building frame member adjacent the rough opening;
inserting the pre-hung door assembly into the rough opening from an interior of the building;
securing the mounting brackets to a first vertical frame member adjacent the rough opening using a plurality of fasteners;
opening the door of the pre-hung door assembly after securing the mounting brackets to the at least one frame member; and
securing the jamb assembly to a second vertical frame member positioned on an opposite side of the rough opening as the first frame member using a plurality of fasteners.

17. The method of claim 16 wherein the mounting brackets are initially provided in a folded configuration for transportation, the method further comprising unfolding the mounting brackets to an open position prior to securing the mounting brackets to the first vertical frame member.

18. A kit for installing a door in a rough opening comprising:
a door frame extending around a perimeter edge of a door panel;
a plurality of hinges attaching the door panel to the door frame comprising a pre-hung door assembly; and
a plurality of mounting brackets attached to the pre-hung door frame, wherein the mounting brackets attached to the interior surface of the rough opening support the door panel for opening and closing before the door frame is attached to the rough opening.

19. The kit of claim 17 wherein the mounting brackets are pivotally attached to the door frame.

20. The kit of claim 17 wherein the mounting brackets are rigidly attached to the door frame.

21. The kit of claim 17 wherein the mounting brackets comprises hinge extensions pivotally attached to the hinges.

22. The kit of claim 17 wherein the mounting brackets comprise a plurality of hinges mounted on an outwardly facing, perimeter surface of the door frame.

23. The kit of claim 17 wherein at least one of the mounting brackets comprises an L-shaped bracket.

24. The kit of claim 17 wherein at least one of the hinges comprise a door side plate, a door frame side plate and at least one of the mounting brackets attached to one of the plates.
